(19) United States
(12) Patent Application Publication
(10) Pub. No.: US 2026/0029192 A1
(43) Pub. Date: Jan. 29, 2026

(54) COOLING FACILITY AND METHOD

(71) Applicant: L'Air Liquide, Societe Anonyme pour l'Etude et l’Exploitation des Procedes Georges Claude, Paris (FR)

(72) Inventors: Pierre BARJHOUX, Sassenage (FR); Golo ZICK, Sassenage (FR); Pierre CRESPI, Sassenage (FR)

(21) Appl. No.: 19/276,326

(22) Filed: Jul. 22, 2025

(30) Foreign Application Priority Data
Jul. 25, 2024 (FR) FR2408254

(51) Int. Cl. F25J 1/00; F25J 1/02; H01B 12/16

(52) U.S. Cl. CPC F25J 1/0015; F25J 1/0017; F25J 1/0067; F25J 1/0211; H01B 12/16; F25J 2260/44; F25J 2270/04; F25J 2280/02

(57) ABSTRACT

The invention relates to a facility for cooling a flow of cryogenic fluid comprising a first circuit for fluid to be cooled, for example liquid nitrogen and/or liquid oxygen, a cryogenic refrigerator with a cycle circuit, at least one heat exchanger providing heat exchange with the first circuit for fluid to be cooled and the cycle circuit of the refrigerator, the facility comprising a second circuit for fluid to be liquefied, for example nitrogen gas and/or oxygen gas, the second fluid circuit being in heat exchange with the cycle circuit of the refrigerator in at least one heat exchanger of the facility, the facility being configured so as to be switchable into a first cooling operating mode, in which the facility cools the first fluid circuit in order to cool a liquefied fluid, preferably in order to generate a quasi-isothermal transformation of said fluid, and a second liquefaction operating mode, in which the facility cools the second fluid circuit with a view to liquefying a gas flow.

### CROSS REFERENCE TO RELATED APPLICATIONS

This application claims the benefit of priority under 35 U.S.C. § 119 and (b) to French patent application No. FR2408254, filed Jul. 25, 2024, which is herein incorporated by reference in its entirety.

### FIELD OF THE INVENTION

The invention relates to a cooling facility and method.

### SUMMARY OF THE INVENTION

More particularly, the invention relates to a facility for cooling a flow of cryogenic fluid comprising a first circuit for fluid to be cooled, for example liquid nitrogen and/or liquid oxygen, a cryogenic refrigerator with a cycle circuit, at least one heat exchanger providing heat exchange with the first circuit for fluid to be cooled and the cycle circuit of the refrigerator, the facility comprising a second circuit for fluid to be liquefied, for example nitrogen gas and/or oxygen gas, the second fluid circuit being in heat exchange with the cycle circuit of the refrigerator in at least one heat exchanger of the facility.

The invention can be advantageously applied to a facility requiring cryogenic fluids for the thermalization of lines at cryogenic temperatures, for example cryogenic fluid pipelines for example for superconductivity applications (cables).

In particular, the invention enables nitrogen and/or oxygen to be liquefied, with mixing possible if required for an end customer's high-temperature superconductivity application.

The gases to be liquefied can be mixed upstream or downstream of the liquefier and the cold fluid can be used to transport electricity at high current density by maintaining an electricity transmission cable in a superconducting state.

The invention makes it possible to replace, at least in part, a supply of cryogenic fluid by delivery lorries by producing the cold necessary at the user site. Another alternative would be the temporary on-site installation of a nitrogen and/or oxygen separation and liquefaction unit (ASU), which is not very cost-effective in terms of time of use and the quantities typically required. Facilities with several tens of kilometres of cables require several thousand tonnes of cryogenic fluid to be built up.

The facility can comprise a unit which is kept superconductive offshore over large distances for transmission of electricity.

In an effort to overcome the deficiencies of the prior art discussed, supra, the facility according to the invention, which otherwise complies with the generic definition given in the above preamble, is configured such that it is configured so as to be switchable into a first cooling operating mode, in which the facility cools the first fluid circuit in order to cool a liquefied fluid, preferably in order to generate a quasi-isothermal transformation of said fluid, and a second liquefaction operating mode, in which the facility cools the second fluid circuit with a view to liquefying a gas flow.

Moreover, embodiments of the invention can comprise one or more of the following features:
the facility_comprises a source of gas to be liquefied connected to the second fluid circuit, for example a source of nitrogen and/or oxygen gas,
the facility_comprises a source of liquid cryogenic fluid connected to the first fluid circuit, for example a source of liquid nitrogen and/or liquid hydrogen,
the facility comprises several heat exchangers in series providing heat exchange between the second fluid circuit and the cycle circuit and at least one heat exchanger in heat exchange with the cycle circuit and comprising separate respective passages for the first fluid circuit and the second fluid circuit within the same heat exchange body,
the refrigerator is of the cycle circuit type subjecting a cycle gas to a thermodynamic cycle with compression in at least one compressor of the cycle circuit driven by a motor and expansion in at least one turbine, the refrigerator being configured to recover work from the or at least one of the turbines to the or at least one compressor, the motor being of the controllable variable-speed type to control the cold power produced,
the facility comprises a network of superconducting cable conduits cooled by a flow of cryogenic liquid such as nitrogen and/or oxygen, said flow of cryogenic liquid being configured to pass through the first fluid circuit in order to cool it.

The invention also relates to a method for cooling such a facility, the method comprising a step of cooling a flow of cryogenic liquid in the first fluid circuit to a temperature below the saturation temperature of the fluid.

According to other possible specific features:
the method comprises, prior to the step of cooling a flow of cryogenic fluid in the first fluid circuit, a step of liquefying a flow of gas in the second fluid circuit, the liquefied gas being transferred into the network of superconducting cable conduits,
the method comprises a step of supplying the second fluid circuit with a mixture of gases to be liquefied, for example nitrogen gas and oxygen gas, the method comprising a step of liquefying said mixture.

The invention may also relate to any alternative device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The invention will be better understood on reading the following description provided purely by way of example and with reference to the appended drawings, in which:

FIG. 1 is a schematic and partial view illustrating an example of the structure and operation of a facility according to the invention.

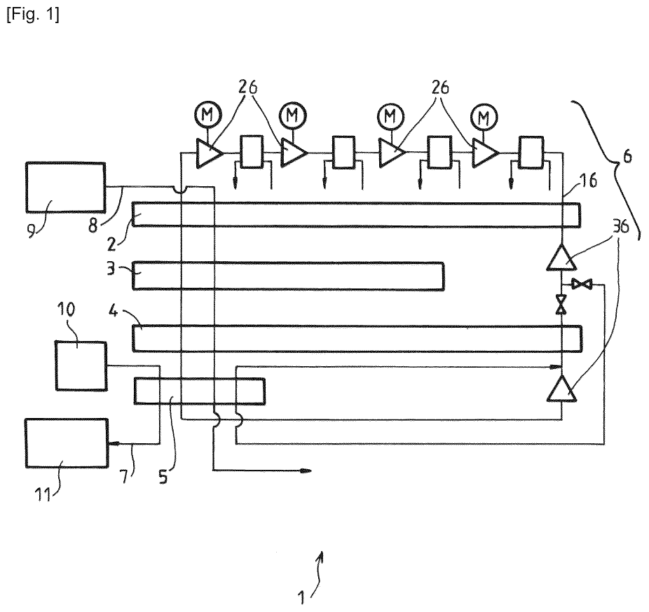

### DETAILED DESCRIPTION OF THE INVENTION

Throughout the figures, the same references relate to the same elements.

In this detailed description, the following embodiments are examples. Although the description refers to one or more embodiments, this does not mean that the features apply only to a single embodiment. Individual features of different embodiments can also be combined and/or interchanged in order to provide other embodiments.

As shown, the facility 1 is configured to cool a flow of cryogenic fluid. This facility 1 comprises a first circuit 7 for fluid to be cooled, for example liquid nitrogen and/or liquid oxygen, a cryogenic refrigerator 6 with a cycle circuit 16 and at least one heat exchanger 5 providing heat exchange between the first circuit 7 for fluid to be cooled and the cycle circuit 16 of the refrigerator 6.

The facility 1 also comprises a second circuit 8 for fluid to be liquefied, for example nitrogen gas and/or oxygen gas. The second fluid circuit 8 is also in heat exchange with the cycle circuit 16 of the refrigerator 6 via at least one heat exchanger 2, 3, 4, 5 of the facility 1.

The facility 1 is configured so as to be switchable into a first cooling operating mode, in which the facility cools the first fluid circuit 7 in order to cool a liquefied fluid, preferably in order to generate a quasi-isothermal transformation of said fluid, and a second liquefaction operating mode, in which the facility 1 cools the second fluid circuit 8 with a view to liquefying a gas flow.

In other words, the facility 1 makes it possible to sub-cool fluids such as liquid nitrogen, liquid oxygen or a mixture of these two components to provide cold power, for example to maintain an electricity transmission cable in a superconducting state.

Similarly, the facility 1 makes it possible to liquefy the above-mentioned gases, for example to cool cryogenic line(s).

To this end, the first circuit 7 supplying the sub-cooled liquid can be connected to a unit comprising cables maintained in a superconducting state. The second fluid circuit 8 can be connected to the unit to provide cooling (cooling of at least a part of the unit).

For example, the facility comprises a network 11 of superconducting cable conduits cooled by a flow of cryogenic liquid such as nitrogen and/or oxygen, and this flow of cryogenic liquid is configured to pass through the first fluid circuit 7 in order to (sub-)cool it.

In particular, this flow of cryogenic liquid in the first fluid circuit 7 can be cooled to a temperature below the saturation temperature of said fluid.

Very large loads of cryogenic liquid may be required to cool such units (in the case for example of circuits of several tens of kilometres of supra-submarine cables). Lower requirements may be needed to keep the unit cool.

Prior to a step of (sub-)cooling a flow of cryogenic fluid in the first fluid circuit 7, the facility can perform a step of liquefying a flow of gas in the second fluid circuit 8. This liquefied gas can be transferred into the network 11 of superconducting cable conduits.

Advantageously, the facility 1 is designed for two cases, bearing in mind that the cooling use case involves considerable logistics for a very rare case.

The gas supply (nitrogen and oxygen, for example) can be provided by a gas separation unit (ASU or preferably of the “APSA” type, and/or a relatively pure nitrogen and/or O2 generator).

The facility is configured to cool this gas or these gases from a temperature significantly higher than the liquefaction temperature of said gas to be liquefied.

Thus, as schematically shown, the facility 1 may comprise a source 9 of gas to be liquefied connected to an upstream end of the second fluid circuit 8, for example a source of nitrogen and/or oxygen gas.

Similarly, the facility may comprise a source 10 of liquid cryogenic fluid connected to an upstream end of the first fluid circuit 7, for example a source of liquid nitrogen and/or liquid hydrogen.

As shown, the facility 1 may comprise several heat exchangers 2, 3, 4, 5 in series providing heat exchange between the second fluid circuit 8 and the cycle circuit 16 and at least one heat exchanger 5 in heat exchange with the cycle circuit 16 and comprising separate respective passages for the first fluid circuit 7 and the second fluid circuit 8 within the same heat exchange body.

The refrigerator 6 is preferably of the cycle circuit 16 type subjecting a cycle gas to a thermodynamic cycle with compression in at least one compressor 26 of the cycle circuit driven by a motor and expansion in at least one turbine 36.

Preferably, the refrigerator 6 is configured to recover work from the or at least one turbine 36 to the or at least one compressor 26 and, also preferably, the or at least a portion of the drive motors for the compressor(s) are of the controllable variable-speed type to control the cold power produced.

The refrigerator 6 is for example of the TurboBrayton cycle type and having two main operating modes (cooling with liquefaction or sub-cooling).

This is possible with this type of refrigerator and particularly in the case of motors driven using VFD (variable frequency drive) technology.

To achieve these two operating modes, the heat exchanger(s) may have dedicated passages for cooling or sub-cooling, respectively, and/or may use identical passages of the heat exchangers.

If the heat exchanger(s) uses (use) the same passages for both operating modes, the exchanger is configured (material and dimensions) to withstand the two corresponding thermal gradient levels.

In the non-limiting example shown, the refrigerator 6 has four compression stages 26 in series (centrifugal compressors) and two centripetal expansion stages 36 in series.

In the case of an offshore facility, a first refrigerator can be provided onshore to liquefy the fluid intended to cool submarine cables, while at least one second remote refrigerator can be provided offshore to cool if required the flow exchanged with the submarine cables.

The first and second refrigerators can operate at different operating conditions despite having an identical structure (to adapt to different thermal loads and conditions).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A facility for cooling a flow of cryogenic fluid comprising:
a first circuit for fluid to be cooled;
a cryogenic refrigerator with a cycle circuit;
at least one heat exchanger providing heat exchange with the first circuit for fluid to be cooled and the cycle circuit of the refrigerator;
a second circuit for a second fluid to be liquefied, for example nitrogen gas and/or oxygen gas, the second fluid circuit being in heat exchange with the cycle circuit of the refrigerator in at least one heat exchanger of the facility;
the facility comprising a source of gas to be liquefied connected to the second fluid circuit; and
a source of liquid cryogenic fluid connected to an upstream end of the first fluid circuit, for example a source of liquid nitrogen and/or liquid hydrogen;
a network of superconducting cable conduits cooled by a flow of a cryogenic liquid selected from the group consisting of liquid nitrogen, liquid oxygen, and combinations thereof, said flow of cryogenic liquid being configured to pass through the first fluid circuit in order to cool the first fluid circuit; and
a plurality of heat exchangers in series providing heat exchange between the second fluid circuit and the cycle circuit and at least one heat exchanger in heat exchange with the cycle circuit and comprising separate respective passages for the first fluid circuit and the second fluid circuit within the same heat exchange body,
wherein the facility is configured so as to be switchable into a first cooling operating mode, in which the facility cools the first fluid circuit in order to cool a liquefied fluid, or into a second liquefaction operating mode, in which the facility cools the second fluid circuit in order to liquefy a gas flow.

2. The facility according to claim 1, wherein the refrigerator is of the cycle circuit type subjecting a cycle gas to a thermodynamic cycle with compression in at least one compressor of the cycle circuit driven by a motor and expansion in at least one turbine, the refrigerator being configured to recover work from the or at least one of the turbines to the or at least one compressor, the motor being of the controllable variable-speed type to control the cold power produced.

3. The facility according to claim 1, wherein the fluid to be cooled is selected from the group consisting of liquid nitrogen, liquid oxygen, and combinations thereof.

4. The facility according to claim 1, wherein the second fluid to be liquefied is selected from the group consisting of gaseous nitrogen, gaseous oxygen, and combinations thereof.

5. The facility according to claim 1, wherein the source of the liquid cryogenic fluid connected to the upstream end of the first fluid circuit is selected from the group consisting of a liquid nitrogen source, a liquid hydrogen source, and combinations thereof.

6. A method for cooling a facility, the method comprising: providing the facility as claimed in claim 1; and cooling a flow of cryogenic liquid in the first fluid circuit to a temperature below the saturation temperature of the fluid.

7. The method according to claim 6, further comprising, prior to the step of cooling a flow of cryogenic fluid in the first fluid circuit, a step of liquefying a flow of gas in the second fluid circuit, the liquefied gas being transferred into the network of superconducting cable conduits.

8. The method according to claim 6, further comprising a step of supplying the second fluid circuit with a mixture of gases to be liquefied, for example nitrogen gas and oxygen gas, the method comprising a step of liquefying said mixture.
